(19) United States
(12) Patent Application Publication
(10) Pub. No.: US 2026/0274264 A1
(43) Pub. Date: Sep. 17, 2026

(54) TRACKING LANE CHANGES BASED ON EXPECTED AND MEASURED VEHICLE DYNAMICS

(71) Applicant: Toyota Motor Engineering & Manufacturing North America, Inc., Plano, TX (US)

(72) Inventors: Yashar Zeiynali Farid, San Jose, CA (US); Maryam Khabazi, Santa Clara, CA (US); Lu Xu, Canton, MI (US); Chunghan Lee, Mountain View, CA (US); Emrah Akin Sisbot, Menlo Park, CA (US); Yusuke Takeuchi, Cupertino, CA (US); Kentaro Oguchi, Mountain View, CA (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/079,627

(22) Filed: Mar. 14, 2025

(51) Int. Cl. B60W 30/18

(52) U.S. Cl. CPC B60W 30/18163; B60W 2520/06; B60W 2520/125; B60W 2520/14; B60W 2540/18; B60W 2540/20; B60W 2552/10; B60W 2552/30; B60W 2552/53; B60W 2556/40

(57) ABSTRACT

Systems, methods, and other embodiments described herein relate to tracking lane changes by a vehicle. In one embodiment, a method includes generating an expected vehicle dynamic parameter value for a road segment based on an extracted feature of the road segment from map data. The method also includes detecting a potential lane change by comparing the expected vehicle dynamic parameter value to a measured vehicle dynamic parameter value of a vehicle traveling along the road segment. The method also includes 1) verifying a lane change by extracting vehicle sensor output indicative of lane change behavior and 2) responsive to a verified lane change, tracking a lane-specific location of the vehicle.

### TECHNICAL FIELD

The subject matter described herein relates, in general, to tracking vehicles along a road segment and, more particularly, to detecting lane movements of the vehicle based on expected and measured vehicle dynamic parameters.

### BACKGROUND

Navigation systems, whether included in a vehicle or run on a mobile device, laptop, or desktop computer, aim to increase the efficiency of road travel for various motorists. Before such systems were implemented, motorists had to rely on paper maps, their memory regarding specific routes, and/or local knowledge to navigate towards a destination. However, this type of navigation is inherently inefficient for a variety of reasons. Paper maps are static and do not dynamically adjust navigational instructions, for example, when a motorist departs from the printed instructions. Moreover, paper maps cannot accommodate changing circumstances such as road closures. Relying on the motorist's memory is also fraught with potential errors as the motorist may have misremembered a navigational step. Still further, while knowing a particular area, a local may be prone to the same mental errors as the motorists, i.e., forgetting navigational steps, etc.

Navigation systems on electronic devices have addressed many of these shortcomings of pre-electronic device systems. For example, multiple routes may exist between an origin and a final destination. Navigation systems generally determine a target route to a destination based on any number of criteria. Example criteria include fuel economy, shortest duration, shortest distance, avoiding certain types of roads (such as toll roads), avoiding active construction zones, and avoiding road accidents, to name a few. With a particular route selected, step-by-step instructions are provided to the motorist, which instructions may be updated as the motorist progresses along and/or departs from the route.

### SUMMARY

In one embodiment, example systems and methods relate to a manner of improving the tracking of vehicles on road segments.

In one embodiment, a lane change tracking system for detecting the lane change maneuvers of a vehicle is disclosed. The lane change tracking system includes a processor and a memory storing machine-readable instructions. The machine-readable instructions, when executed by the processor, cause the processor to generate an expected vehicle dynamic parameter value for a road segment based on an extracted feature of the road segment from map data. The machine-readable instructions also, when executed by the processor, cause the processor to detect a potential lane change by comparing the expected vehicle dynamic parameter value to a measured vehicle dynamic parameter value of a vehicle traveling along the road segment. The machine-readable instructions also, when executed by the processor, cause the processor to 1) verify a lane change by extracting vehicle sensor output indicative of lane change behavior and 2) responsive to a verified lane change, track a lane-specific location of the vehicle.

In one embodiment, a non-transitory computer-readable medium for detecting the lane change maneuvers of a vehicle is disclosed. The non-transitory computer-readable medium includes instructions that, when executed by a processor, cause the processor to perform one or more functions. The instructions include instructions to generate an expected vehicle dynamic parameter value for a road segment based on an extracted feature of the road segment from map data. The instructions also include instructions to detect a potential lane change by comparing the expected vehicle dynamic parameter value to a measured vehicle dynamic parameter value of a vehicle traveling along the road segment. The instructions also include instructions to 1) verify a lane change by extracting vehicle sensor output indicative of lane change behavior and 2) responsive to a verified lane change, track a lane-specific location of the vehicle.

In one embodiment, a method for detecting the lane change maneuvers of a vehicle is disclosed. In one embodiment, the method includes generating an expected vehicle dynamic parameter value for a road segment based on an extracted feature of the road segment from map data. The method also includes detecting a potential lane change by comparing the expected vehicle dynamic parameter value to a measured vehicle dynamic parameter value of a vehicle traveling along the road segment. The method also includes 1) verifying a lane change by extracting vehicle sensor output indicative of lane change behavior and 2) responsive to a verified lane change, tracking a lane-specific location of the vehicle.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a lane change tracking system that is associated with detecting the lane change maneuvers of a vehicle.

FIG. 3 illustrates one embodiment of the lane change tracking system of FIG. 2 in a cloud-computing environment.

FIG. 4 illustrates a flowchart for one embodiment of a method that is associated with detecting the lane change maneuvers of a vehicle, according to an example of the principles described herein.

FIGS. 5A and 5B depict the different vehicle dynamic parameter values for different types of vehicles.

FIGS. 6A and 6B depict the detection of a lane change based on road segment centerline and vehicle steering angle, according to an example of the principles described herein.

FIG. 7 depicts the detection of a lane change based on road segment curvature and vehicle heading, according to an example of the principles described herein.

FIG. 8 depicts the detection of a lane change based on road lane data and vehicle yaw, according to an example of the principles described herein.

FIG. 9 depicts the detection of a lane change based on road segment lane data, according to an example of the principles described herein.

FIG. 10 illustrates a flowchart for one embodiment of a method that is associated with detecting the lane change maneuvers of a vehicle, according to an example of the principles described herein.

FIG. 11 depicts various driver assistance operations executed based on lane-specific locations of the vehicle and other vehicles.

### DETAILED DESCRIPTION

Systems, methods, and other embodiments associated with improving vehicle tracking are disclosed herein. As previously described, navigation systems aid in directing a vehicle from an origin to a destination. Some navigation systems rely on traffic data to generate the instructions. For example, a navigation system may 1) instruct a motorist to avoid a section of road due to elevated traffic congestion along that section and 2) provide detour instructions to guide the driver around the congested area.

The present system may provide navigation at a finer resolution. That is, some systems may provide road-specific navigational instructions, which are undoubtedly helpful in guiding motorists through complex and sometimes unfamiliar road networks. By comparison, the system of the present specification provides lane-level navigational instructions to a vehicle and/or lane-level autonomous control over the vehicle. The navigational instructions and navigational control are based on lane-specific traffic conditions.

Specifically, a lane change tracking system on the vehicle or a remote server may track the lane movement of the vehicle on the road. Based on the lane position and lane changes of the vehicle and the lane position and lane changes of other vehicles, the lane change tracking system may calculate traffic conditions within each lane. Lane-specific navigational instructions and/or control may be generated based on these lane-specific traffic conditions.

The present system does so without transmitting images of the environment, which may be computationally expensive and complex to send and take up a large portion of the vehicle's or remote server's memory databanks. For example, some systems provide road-level traffic data based on image data collected by various vehicles on the road. Transmitting this image data may be computationally expensive and clog up a wireless communications network, thus negatively impacting other transmissions of data between a remote server and the vehicles on a roadway.

Accordingly, rather than determining a vehicle's lane position based on images captured by the vehicle, which images are then wirelessly transmitted to a remote server for processing, the present specification describes a lane tracking system that efficiently and simply determines the position of a vehicle in a more computationally conservative fashion, thus freeing up the processing resources of the vehicle or remote server and potentially freeing up bandwidth on an already congested communication network.

Specifically, the present lane change tracking system detects lane changes based on map data and expected vehicle dynamics. That is, a vehicle may be expected to operate with various dynamic values (e.g., steering wheel angle, lateral acceleration, heading, etc.) while traveling along a road. The specific expected values are determined, at least in part, based on the characteristics of the road. Accordingly, the vehicle transmits its sensor data, which indicates measured vehicle dynamic parameter values (e.g., measured steering wheel angle, measured lateral acceleration, measured yaw, and measured heading) to a lane change tracking system (whether on-vehicle or on a cloud server). The lane change tracking system performs map matching to localize the vehicle along a road. The lane change tracking system also acquires road features (e.g., centerline, curvature, number of lanes, lane marker types, and lane drops/additions) from the map data. The lane change system then calculates expected vehicle dynamic parameter values (e.g., expected steering wheel angle, expected lateral acceleration, expected yaw, and expected heading) from the map data. The lane change system compares the expected vehicle dynamic parameter values against the measured vehicle dynamic parameter values to identify potential lane change maneuvers. For example, deviations may be flagged as potential lane change maneuvers.

In one example, this comparison identifies potential lane changes whether a vehicle is traveling on a straight or curved road. That is, a vehicle may be expected to exhibit certain vehicle dynamics while traveling around a curve on the road. These expected vehicle dynamics may differ from those expected when the vehicle performs a lane change while traveling around the curve. Both of these expected profiles differ from what would be expected if the vehicle traveled along a straight road. Accordingly, the present system can differentiate between a vehicle traveling around a curve while not changing lanes and a vehicle traveling around a curve while changing lanes.

In one particular example, the expected vehicle dynamic parameter values may be based on a characteristic or type of the vehicle. That is, different vehicles have different dynamics (e.g., lateral acceleration, yaw, heading, and steering angle) when performing a maneuver, even when traveling on the same road. For example, the steering wheel angle of a sedan changing a lane may be different than the steering wheel angle of a semi-truck changing a lane. The current lane change tracking system identifies expected values based on vehicle-specific characteristics. Accordingly, measured vehicle dynamic parameter values may be compared against vehicle-specific expected vehicle dynamic parameter values.

In either case, the lane change tracking system may verify that a detected potential lane change is, in fact, a lane change. That is, were a single data point (i.e., deviation of a measured vehicle dynamic parameter value from an expected vehicle dynamic parameter value) relied on, a false positive indication of a lane change may be generated, which false positive can then propagate through to the navigation system and/or automated driving module operations. Accordingly, the present lane change tracking system processes vehicle sensor data, such as camera images, inertial measurement unit (IMU) output, lateral displacement data, and vehicle blinker status, among others, to verify that a potential lane change is, in fact, a lane change. As described above, the lane-level position information may be used by in-vehicle navigation systems, automated driving modules, and/or remote traffic centers to increase the efficiency of vehicle navigation and control.

In this way, the disclosed systems, methods, and other embodiments improve vehicle tracking by providing lane-specific vehicle tracking and finer granularity traffic information, navigational instructions, and autonomous control. That is, rather than providing road-level traffic information, the lane change tracking system can provide lane-level traffic information, thus increasing the accuracy and resolution of information provided to motorists navigating a road.

The present lane change tracking system also provides new traffic congestion and vehicle tracking input data (e.g., steering wheel angle, heading, yaw, lateral acceleration), thus enhancing traffic and vehicle monitoring system capability.

In the case where the lane change tracking system is a machine-learning system, new types of inputs are provided, which enhances the functionality of a machine-learning inference. Each of these improvements is further enhanced when vehicle-specific information is also provided. That is, the present system enhances traffic prediction (whether machine-learning-based or not) and autonomous driving control by basing such on the specific vehicle and the vehicle dynamics unique to the specific vehicle.

Still further, by relying on secondary indicia (i.e., environment sensor data) to corroborate a detected potential lane change, the present lane change tracking system avoids false positives by considering supporting indicia to more reliably conclude that a vehicle has changed lanes. Accordingly, the present system improves vehicle tracking by basing such on vehicle data and by confirming a lane change with secondary data.

Still further, the present lane change tracking system improves vehicle tracking based on road-specific data. That is, existing systems may be unable to differentiate between a vehicle traveling around a curve on the road and a vehicle changing lanes while traveling around the curve on the road. Accordingly, by accounting for road-specific data such as curvature, etc., the present system increases the sensing capability of a vehicle tracking system.

Even further, all this is accomplished in a fashion that reduces the computational load of a traffic center and/or vehicle tracking processor. That is, a vehicle tracking processor, whether on the vehicle or at a remote location, may track the location of hundreds or thousands of vehicles in a region. This load may overwhelm the processor, especially if each vehicle transmits large files such as image files, video streams, etc. Accordingly, by tracking a vehicle based on smaller data, the present lane change tracking system reduces the computational load of a computer, thus freeing up valuable processing resources to perform other safety-enhancing operations. Moreover, the smaller data sizes also reduce the transmission bandwidth across a wireless network, freeing up valuable transmission resources to perform other safety-enhancing operations. The reduced computational load and transmission bandwidth may ultimately reduce the latency and disruptions in service, which can be problematic, for example, when navigational instruction and remote autonomous control are provided. Accordingly, the present system improves computer functionality, specifically vehicle tracking and control functionality, by reducing computational load and processing bandwidth. All this occurs while providing finer granularity traffic information (i.e., lane-level traffic information instead of road-level traffic information).

While particular reference is made to detecting lane changes on straight or curved roads, the present lane change tracking system may be implemented on other complex geometries, such as winding roads. That is to say, where existing lane change detection systems may not have been able to differentiate lane changes from navigation along a complex roadway, the present system does so by comparing an expected vehicle dynamic parameter value for the complex road with measured dynamics values of a vehicle driving along the complex road.

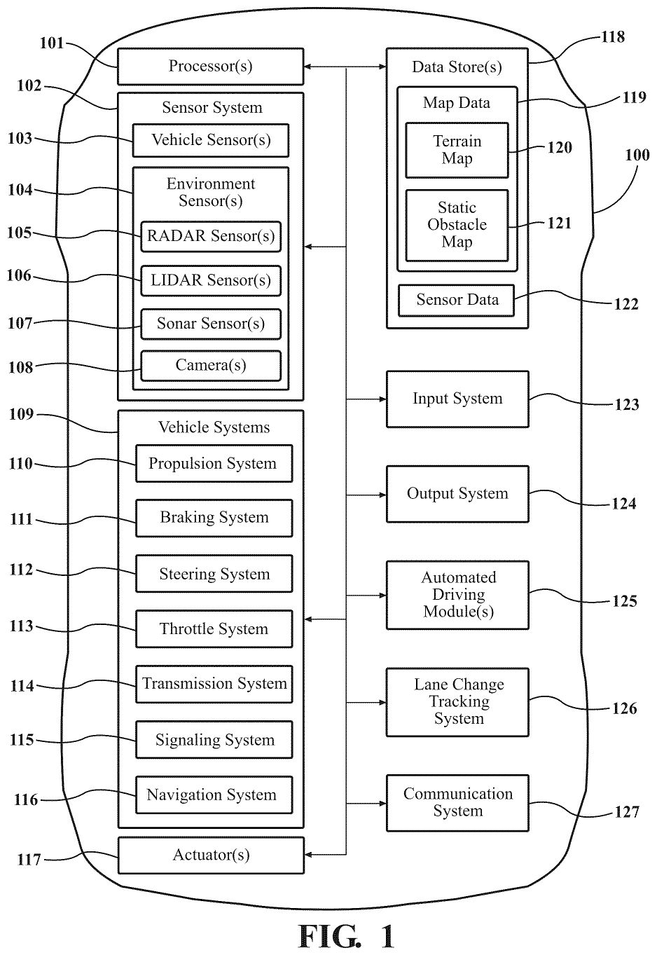

Referring to FIG. 1, an example of a vehicle 100 is illustrated. As used herein, a “vehicle” is any form of transport that may be motorized or otherwise powered. In one or more implementations, the vehicle 100 is an automobile. While arrangements will be described herein with respect to automobiles, it will be understood that embodiments are not limited to automobiles. In some implementations, the vehicle 100 may be a robotic device or a form of transport that, for example, includes sensors to perceive aspects of the surrounding environment, and thus benefits from the functionality discussed herein associated with providing lane-level tracking.

The vehicle 100 also includes various elements. It will be understood that in various embodiments it may not be necessary for the vehicle 100 to have all of the elements shown in FIG. 1. The vehicle 100 can have different combinations of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances. For example, as discussed, one or more components of the disclosed system can be implemented within a vehicle while further components of the system are implemented within a cloud-computing environment or other system that is remote from the vehicle 100.

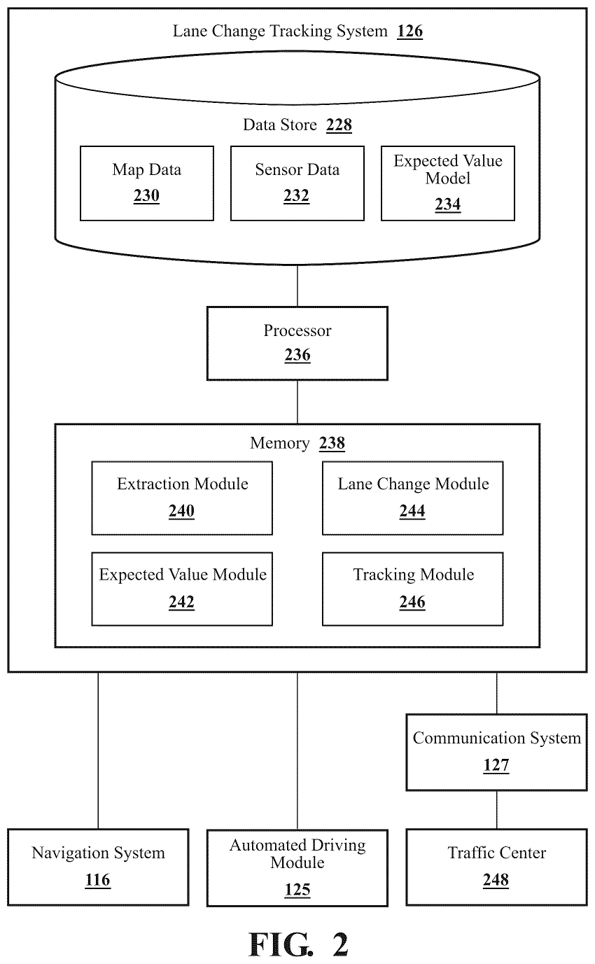

Some of the possible elements of the vehicle 100 are shown in FIG. 1 and will be described along with subsequent figures. However, a description of many of the elements in FIG. 1 will be provided after the discussion of FIGS. 2-11 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, the vehicle 100 includes a lane change tracking system 126 that is implemented to perform methods and other functions as disclosed herein relating to improving lane-level vehicle tracking.

As will be discussed in greater detail subsequently, the lane change tracking system 126, in various embodiments, is implemented partially within the vehicle 100, and as a cloud-based service. For example, in one approach, functionality associated with at least one module of the lane change tracking system 126 is implemented within the vehicle 100 while further functionality is implemented within a cloud-based computing system. Thus, the lane change tracking system 126 may include a local instance at the vehicle 100 and a remote instance that functions within the cloud-based environment.

Moreover, the lane change tracking system 126, as provided for within the vehicle 100, functions in cooperation with a communication system 127. In one embodiment, the communication system 127 communicates according to one or more communication standards. For example, the communication system 127 can include multiple different antennas/transceivers and/or other hardware elements for communicating at different frequencies and according to respective protocols. The communication system 127, in one arrangement, communicates via a communication protocol, such as a WiFi, dedicated short-range communication (DSRC), vehicle-to-infrastructure (V2I), vehicle-to-vehicle (V2V), or another suitable protocol for communicating between the vehicle 100 and other entities in the cloud environment. Moreover, the communication system 127, in one arrangement, further communicates according to a protocol, such as global system for mobile communication (GSM), Enhanced Data Rates for GSM Evolution (EDGE), Long-Term Evolution (LTE), 5G, or another communication technology that provides for the vehicle 100 communicating with various remote devices (e.g., a cloud-based server). In any case, the lane change tracking system 126 can leverage various wireless communication technologies to provide communications to other entities, such as members of the cloud-computing environment.

With reference to FIG. 2, one embodiment of the lane change tracking system 126 of FIG. 1 is further illustrated. Note that the lane change tracking system 126 may be implemented in the vehicle 100, as depicted in FIG. 1, or a remote system. In either case, the lane change tracking system 126 is shown as including a processor 236. In an example, the processor 236 is an example of the processor 101 from the vehicle 100 of FIG. 1. Accordingly, the processor 101 may be a part of the lane change tracking system 126, the lane change tracking system 126 may include a separate processor from the processor 101 of the vehicle 100, or the lane change tracking system 126 may access the processor 101 through a data bus or another communication path that is separate from the vehicle 100.

In one embodiment, the lane change tracking system 126 includes a memory 238 that stores an extraction module 240, an expected value module 242, a lane change module 244, and a tracking module 246. The memory 238 is a random-access memory (RAM), read-only memory (ROM), a hard-disk drive, a flash memory, or another suitable memory for storing the modules 240, 242, 244, and 246. The modules 240, 242, 244, and 246 are, for example, computer-readable instructions that, when executed by the processor 236, cause the processor 236 to perform the various functions disclosed herein. In alternative arrangements, the modules 240, 242, 244, and 246 are independent elements from the memory 238 that are, for example, comprised of hardware elements. Thus, the modules 240, 242, 244, and 246 are alternatively ASICs, hardware-based controllers, a composition of logic gates, or another hardware-based solution.

Moreover, in one embodiment, the lane change tracking system 126 includes the data store 228. In an example, the data store 228 is an example of the data store 118 from the vehicle 100 of FIG. 1. In an example, the data store 228 is a separate data store 118 from that depicted in FIG. 1. The data store 228 is, in one embodiment, an electronic data structure stored in the memory 238 or another data storage device and that is configured with routines that can be executed by the processor 236 for analyzing stored data, providing stored data, organizing stored data, and so on. Thus, in one embodiment, the data store 228 stores data used by the modules 240, 242, 244, and 246 in executing various functions.

Specifically, in an example, the data store 228 includes map data 230 of different road segments that the vehicle 100 may traverse. In an example, the map data 230 is a cached version of a portion of map data 230 downloaded from a remote server. In another example, the map data 230 may be more comprehensive. In either example, the map data 230 may include a geographical representation of road segments that the vehicle 100 may encounter. In an example, the map data 230 may indicate features of the road network and different road segments. For example, the map data may indicate a centerline of the road. The centerline of the road may be represented as a discrete series of location coordinates (e.g., global positioning system (GPS) coordinates) along the road. Each node along the road may be connected by a straight line such that the map data 230 is a network of nodes connected by edges, each node including a geographic coordinate (e.g., a GPS coordinate) for the road. In general, the GPS coordinate may be of a central location of the road rather than an edge of the road.

In another example, the map data 230 may include a curvature of the road. In an example, this curvature value for a particular location along the road may be calculated and manually entered during map creation. In another example, the curvature of the road may be calculated using GPS coordinates of adjacent nodes of the map data 230. In either example, the map data 230 may include data indicating the curvature of the road.

In another example, the map data 230 may indicate the number of lanes along a road and/or changes to the number of lanes of a road. For example, a road may be a one-lane road and/or may include different numbers of lanes through different regions. In either case, the map data 230 may be tagged with metadata indicating the number of lanes and changes to the number of lanes across the road network. In another example, the map data 230 may be lane agnostic, meaning that the map data 230 does not indicate the specific lanes of an associated road. In this example, the lane change tracking system 126 may still be able to determine when a lane change occurs based on vehicle dynamic parameter values as described below.

The data store 228 may also include sensor data 232. In general, the sensor data 232 is data from the vehicle 100, by which an actual lane change is detected. As described in more detail below, a potential lane change is identified by evaluating data indicative of vehicle dynamics. In general, vehicle dynamics describe how a vehicle moves across the road. The vehicle 100 may include a variety of sensors that measure different aspects of vehicle dynamics. For example, the vehicle 100 may include a steering wheel sensor that determines the angle of a steering wheel. As another example, the vehicle 100 may include a wheel angle sensor that measures the yaw angle of a wheel at any point in time. As another example, a vehicle may include an inertial measurement unit (IMU), an accelerometer, a gyroscope, or a GPS sensor, from which a lateral acceleration, position, and/or displacement may be determined. While specific reference is made to specific vehicle sensors 103, the vehicle 100 may include a variety of other sensors that measure different aspects of the dynamic movement of the vehicle, which data may be logged in the data store 228 as sensor data 232.

The sensor data 232 may also include data used to confirm that an actual lane change occurred. This data may also take a variety of forms. For example, the vehicle 100 may be equipped with a turn signal, which is activated to signal to other drivers that the vehicle 100 is about to change lanes. The turn signal output may be included in the sensor data 232. As yet another example, camera images of the surrounding environment may be relied on to affirm the lane change. For example, a change to the detected lane markers on either side of the vehicle 100 may confirm that the vehicle dynamic-based prediction of a lane change is a lane change maneuver rather than some other type of maneuver. Other examples of sensor data 232 that may be included in the data store 228 include LiDAR sensor 106 data, radar sensor 105 data, and sonar sensor 107 data.

In one embodiment, the data store 228 stores the sensor data 232 along with, for example, metadata that characterizes various aspects of the sensor data 232. For example, the metadata can include location coordinates (e.g., longitude and latitude), relative map coordinates or tile identifiers, time/date stamps from when the separate sensor data 232 was generated, and so on. Of particular relevance, the metadata may indicate the road curvature, road centerline, and number of lanes at different points along the roadway as described above.

In one embodiment, the data store 228 further includes an expected value model 234. In general, the expected value model 234 is relied on by the expected value module 242 to determine the expected vehicle dynamic parameter values based on extracted road features. That is, for given road features, there may be certain vehicle dynamic parameter values that the vehicle 100 would be expected to exhibit while navigating the road with those features. The expected value model 234 may include the data and functions used to determine those expected vehicle dynamic parameter values.

In an example, the expected value model 234 may include a series of lookup tables that map road features to expected vehicle dynamic parameter values. For example, a lookup table may map road curvatures to expected steering wheel angles. That is to say, it may be expected that for a given road curvature value, there is an expected steering wheel angle range, which range indicates the steering wheel values a vehicle would have while navigating the road given the road curvature value. While particular reference is made to a particular mapping (e.g., between a particular road feature and a particular vehicle dynamic parameter), the expected value model 234 may include other lookup tables that map other road features to other expected vehicle dynamic parameter values.

In an example, the lookup tables may be indexed by vehicle type and/or characteristic. That is, different vehicles 100 may exhibit different dynamic characteristics while navigating the same road. For example, a truck towing a boat may have less lateral acceleration when making a lane change than a sedan. As another example, a sports car may have a greater steering angle when making a lane change than a heavy-duty truck. All this is to say that the different performance characteristics of different vehicles affect an expected vehicle dynamic parameter, given a particular road feature. In this example, the expected value model 234 may include mappings per vehicle type (e.g., make, model, year, etc.) and/or per vehicle characteristic (e.g., wheelbase, weight, etc.).

In an example, the expected value module 242 may be a machine-learning system that generates the expected vehicle dynamic parameter values based on identified patterns in a corpus of sensor data 232 and map data 230. In the context of the present application, a machine-learning-based expected value module 242 relies on some form of machine-learning, whether supervised, unsupervised, reinforcement, or any other type, to identify expected vehicle dynamic parameter values based on sensor data 232 and map data 230. The lane change module 244 uses those expected vehicle dynamic parameter values to infer a lane change maneuver of the vehicle 100. In any case, the expected value model 234 may include the weights (including trainable and non-trainable), biases, variables, activation functions, rules, algorithms, parameters, and other elements that operate to output a vehicle-specific expected vehicle dynamic parameter values based on sensors that measure vehicle dynamics of the vehicle 100.

As described above, the lane change tracking system 126 includes various modules that facilitate the functionality described herein. Specifically, the lane change tracking system 126 includes an extraction module 240 that includes instructions that cause the processor 236 to extract features of a road segment from map data 230. As described above, the map data 230, in addition to depicting the geographical interconnection of various roads, may include metadata indicating features of the road segments. Examples of features of a road segment that may be relied on to differentiate non-lane changing navigation of the road segment from a lane change on the road segment include a centerline of the road segment, a curvature of the road segment, a number of lanes of the road segment, a change to the number of lanes of a road segment, and the presence of and type of lane markers on the road segment.

In an example, the format of the centerline data may be a sequence of GPS coordinates at discrete points, or “nodes” along the road, and the connection of the nodes via edges. In an example, this centerline data and other data may be manually input via an administrator of a map database. As described above, the format of the curvature of the road segment may be a curvature value at a particular node of the map data 230. As described above, the curvature may be calculated based on adjacent node coordinates along the road segment. An example format of the number of lanes of the road segment may be an integer value indicating a number of lanes. For example, a single-lane road may be represented by the integer “1” in the metadata associated with the nodes that fall along the single-lane road. An example format of a change to the number of lanes may be a difference in the adjacent node's integer values that indicate the number of lanes. An example format for the lane markers on the road segment may be a bit that identifies the presence of different types of lane markers, such as continuous, dashed, etc. In other words, the metadata for the map data 230 may indicate the different road characteristics (e.g., centerline coordinate, curvature, number of lanes, presence and type of lane markers) per node. The form of the metadata may vary, for example, with each characteristic taking a place in a multi-digit representation. In either case, the extraction module 240 extracts these characteristic features for the road in the environment of the vehicle 100.

Accordingly, the extraction module 240, in one embodiment, controls the respective sensors to provide the data inputs in the form of the sensor data 232. Additionally, while the extraction module 240 is discussed as controlling the various sensors to provide the sensor data 232, in one or more embodiments, the extraction module 240 can employ other techniques to acquire the sensor data 232 that are either active or passive. For example, the extraction module 240 may passively sniff the sensor data 232 from a stream of electronic information provided by the various sensors to further components within the vehicle 100.

The lane change tracking system 126 further includes an expected value module 242 that includes instructions that, when executed by the processor 236, cause the processor 236 to generate an expected vehicle dynamic parameter value for a road segment based on an extracted feature of the road segment from map data 230. That is, for a given road feature, a vehicle 100 may be expected to exhibit certain vehicle dynamics. For example, while driving along a straight road, the yaw, steering wheel angle, wheel angle, and lateral acceleration all may be expected to have values of zero or within a threshold range of zero while the vehicle heading (relative to true north) may be expected to match or be within a threshold range from the heading (relative to true north) of the road. As a more complex example, vehicles traveling along a curved road may be expected to exhibit vehicle dynamics with different parameter values, which parameter values depend upon the radius of curvature of the road, number of lanes on the road, lane additions/drops, etc. Accordingly, in general, the expected value module 242 may determine what vehicle dynamic parameter values are expected for a given road segment, given an extracted feature of the road segment. Example vehicle dynamic parameter values include but are not limited to, an expected steering wheel angle value, an expected lateral acceleration value, an expected wheel angle value, an expected heading value, and an expected yaw value.

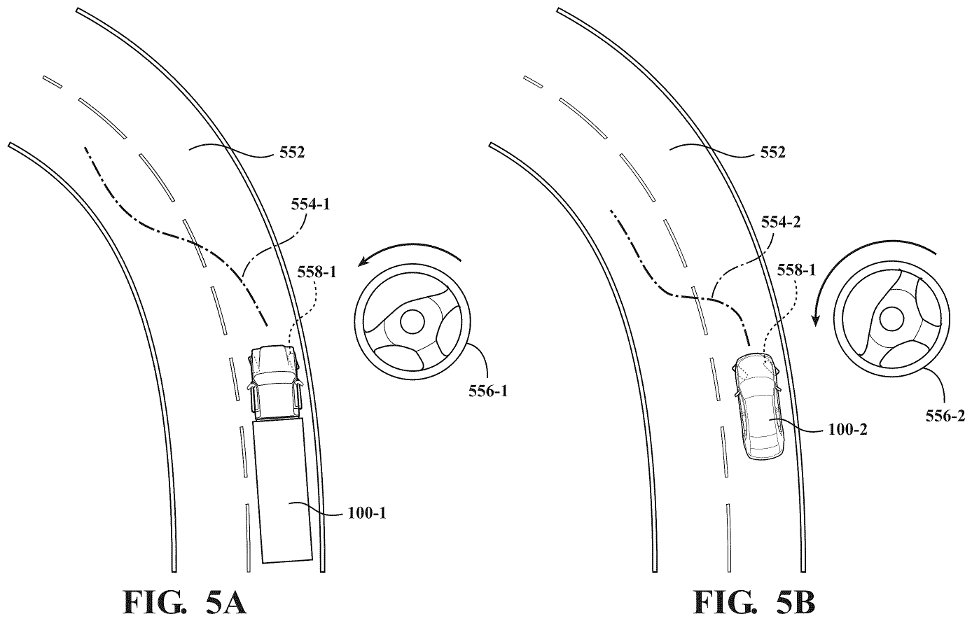

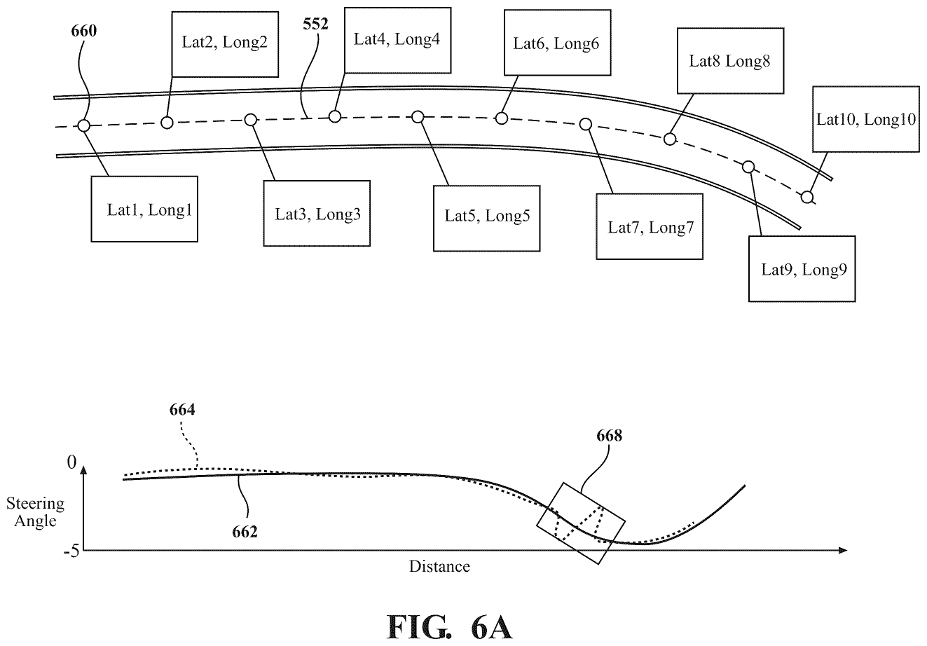

As described above, any of these expected vehicle dynamic parameter values may be determined based on any number or any combination of the aforementioned road features (e.g., centerline, curvature, number of lanes, lane marker types, lane drops/additions). Examples of such are provided below in connection with FIG. 5A-9.

The determination of the expected vehicle dynamic parameter value may be performed in a variety of ways. For example, as described above, the expected value model 234 may include lookup tables that map one or more road features to one or more expected vehicle dynamic parameter values. As one specific example, a lookup table may indicate that for a road segment with a radius of curvature of 500 meters (m) and a curvature of .002 m⁻¹, the lookup table may dictate an expected steering wheel angle of between 3 and 9 degrees of angular rotation. The expected value module 242 may rely on similar one-to-one or multiple-to-one mappings when determining the lookup table-based expected vehicle dynamic value parameter.

As another example, the expected value module 242 may be a machine-learning module. The machine-learning module may be an unsupervised, supervised, or reinforced learning module. In this example, the inputs to the machine-learning module may be a single road feature or multiple road features as extracted from the map data 230. Nodes within the machine-learning module process the road features to output expected vehicle dynamic parameter values.

As described above, in some examples, the determination of an expected vehicle dynamic parameter value may be based on the type of the vehicle 100 and/or a characteristic of the vehicle 100. With a machine-learning type expected value module 242, the type and/or characteristic of the vehicle 100 may be an additional input, and the training data, when relied on, may also be trained on various vehicle types and characteristics. With a lookup table-based expected value module 242, the lookup tables may be indexed by vehicle type and/or characteristic.

In any case, as described above, the expected value module 242 receives extracted road features from the extraction module 240. Based on the extracted road features and the expected value model 234 (whether the expected value model 234 includes lookup tables or machine-learning weights, biases, activation functions, etc.), the expected value module 242 determines the expected dynamic parameter values for the vehicle 100 as it travels along the roadway defined by the map data 230.

In an example, the expected value module 242 includes instructions that cause the processor 236 to compile multiple expected vehicle dynamic parameter values into a profile that comprises multiple location-specific expected vehicle dynamic parameter values at different locations along the road segment. That is to say, the expected value module 242 may determine the expected vehicle dynamic parameter value(s) per node. The expected value module 242 may generate a profile indicating the expected vehicle dynamic parameter value(s) for multiple sequential nodes. In this example, the lane change module 244 may detect a lane change based not only on a comparison of one expected data point with a measured data point but also on a sequence of data points, thus increasing the efficiency and accuracy of lane change detection. That is, it may be that lane change detection is evaluated over multiple nodes instead of one.

In one approach, the expected value module 242 implements and/or otherwise uses a machine learning algorithm. In one configuration, the machine learning algorithm is embedded within the expected value module 242, such as a neural network to perform inference over the map data 230. Of course, in further aspects, the expected value module 242 may employ different machine learning algorithms or implement different approaches for performing the inference. Whichever particular approach the expected value module 242 implements, the expected value module 242 provides an output with expected vehicle dynamic parameter values.

In one or more configurations, the lane change tracking system 126 implements one or more machine learning algorithms. As described herein, a machine learning algorithm includes but is not limited to deep neural networks (DNN), including transformer networks, convolutional neural networks, recurrent neural networks (RNN), etc., Support Vector Machines (SVM), clustering algorithms, Hidden Markov Models, and so on. It should be appreciated that the separate forms of machine learning algorithms may have distinct applications, such as agent modeling, machine perception, and so on.

Moreover, it should be appreciated that machine learning algorithms are generally trained to perform a defined task. Thus, the training of the machine learning algorithm is understood to be distinct from the general use of the machine learning algorithm unless otherwise stated. That is, the lane change tracking system 126 or another system generally trains the machine learning algorithm according to a particular training approach, which may include supervised training, self-supervised training, reinforcement learning, and so on. In contrast to training/learning of the machine learning algorithm, the lane change tracking system 126 implements the machine learning algorithm to perform inference. Thus, the general use of the machine learning algorithm is described as inference.

It should be appreciated that the expected value module 242 in combination with the expected value model 234 can form a computational model such as a neural network model. In any case, the expected value module 242, when implemented with a neural network model or another model, in one embodiment, implements functional aspects of the expected value model 234, while further aspects, such as learned weights, may be stored within the data store 228. Accordingly, the expected value model 234 is generally integrated with the expected value module 242 as a cohesive functional structure.

The lane change tracking system 126 further includes a lane change module 244 that includes instructions that, when executed by the processor 236, cause the processor 236 to detect a potential lane change by comparing the expected vehicle dynamic parameter value to a measured vehicle dynamic parameter value of the vehicle 100 traveling along the road segment. That is, as the vehicle 100 traverses along a road segment, vehicle sensors measure the vehicle dynamics, which include but are not limited to a measured steering wheel angle value, a measured lateral acceleration value, a measured wheel angle value, a measured heading value, and a measured yaw value. Based on a comparison of the measured vehicle dynamic parameter values with the road-specific expected vehicle dynamic parameter values, the lane change module 244 may determine whether the measured vs. expected values are different enough to categorize a particular movement pattern as likely to indicate a lane change or not.

For example, returning to the example above, the expected steering wheel angle of between 3 and 9 degrees may be expected for a road segment with a radius of 500 meters (m) and a curvature of .002 m⁻¹. In this example, a steering wheel sensor may measure, as the vehicle drives along the curved road, an actual steering wheel angle of the vehicle 100 to be 10 degrees. This difference alone, or in combination with measured vs. expected value comparisons at other nodes, may indicate that the vehicle 100 is not just navigating the curved road but is also executing a lane change maneuver. By comparison, a steering wheel sensor of a second vehicle may measure, as the second vehicle drives along the curved road, an actual steering wheel angle to be 7 degrees. This similarity alone or combined with measured vs. expected value comparisons at other nodes, may indicate that the second vehicle is navigating the curved road without changing lanes.

In the example above, the lane change module 244 compares the measured values against expected values defining non-lane change behavior. However, in other examples, the lane change module 244 may compare the measured values against expected values that define lane-change behavior. For example, the expected steering wheel angle of between 10 and 12 degrees may suggest that a vehicle has moved to an inside lane while traveling along a curved road. In this example, a steering wheel sensor of the vehicle may measure the actual steering wheel angle of the vehicle 100 to be 11 degrees. This similarity alone, or in combination with measured vs. expected value comparisons at other nodes, may indicate that the vehicle is executing an inside lane change along the curved road. As depicted in examples below, the lane change module 244 may determine a potential lane change based on any number or any combination of extracted features and any number or any combination of expected vehicle dynamic parameters.

In addition to identifying a potential lane change, the lane change module 244 may include instructions that cause the processor 236 to verify a lane change by extracting vehicle sensor output indicative of lane change behavior. That is, to avoid a false positive indication of a lane change, which could lead to inaccurate navigational instructions and/or autonomous control, the lane change module 244 may verify the results of the comparison of measured and expected values. To do so, the lane change module 244 may rely on any number of secondary indicia of lane change behavior. That is, there may be different behaviors or conditions suggesting a lane change has occurred. As a verification operation, the lane change module 244 can evaluate these secondary indicia.

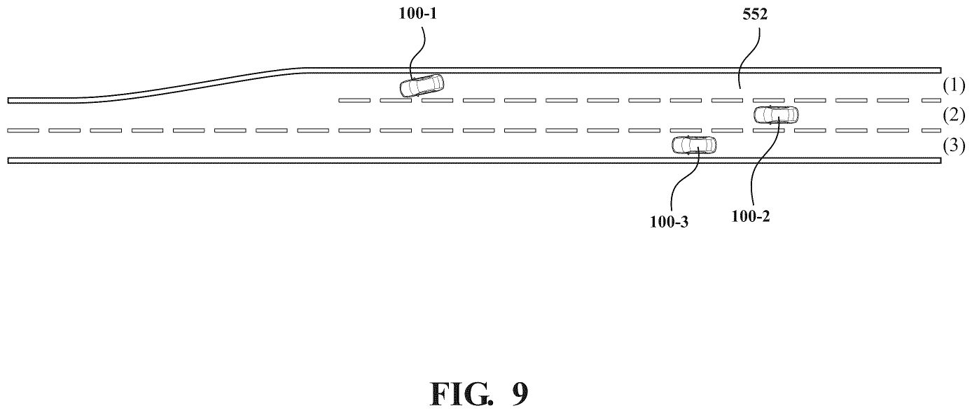

As an example of lane change verification, the lane change module 244 may detect, from sensor data 232, at least one of a lane drop or a lane addition. Specifically, a vehicle 100 may include environment sensors 104 that capture information about the surrounding environment, including the road on which the vehicle 100 is traveling. An image processor of the lane change module 244 may process these images to detect and track lane markers on the road. The removal or addition of a lane may be indicative of a lane change. Additional details regarding detecting lane drops or additions to verify a lane change are provided below in connection with FIG. 9.

As another example, the number of lanes may serve to verify an actual lane change. For example, a vehicle 100 may be navigating a one-way road. In an example where a potential lane change is detected based on a comparison of measured and expected values, the lane change module 244 may determine that a lane change did not occur as there is no ability to change lanes on a one-way road. For example, it may have been that the vehicle 100 was merely passing a slow-moving vehicle as prescribed by local laws and road markings.

As another example, the lane change module 244 may verify a lane change based on the change of lane markers to either side of the vehicle 100. For example, before a lane change, cameras 108 of the vehicle 100 may identify a solid line on the right-hand side of the vehicle 100 and a dashed line on the left-hand side of the vehicle 100. By comparison, the camera 108 of the vehicle 100 may identify dashed lines on both sides of the vehicle 100 following a detected potential lane change. In this example, the lane change module 244 may consider sensor data 232 captured before and after a detected potential lane change to confirm the performance of a lane change maneuver or contradict the comparison-based determination.

As another example, the lane change module 244 may verify the lane change based on a detected lateral displacement of the vehicle 100. For example, lanes on a road may have a predetermined width. If the lateral displacement of the vehicle 100 is not greater than the lane width, the lane change module 244 may infer that the vehicle 100, while potentially deviating from expected behavior, did not deviate enough to constitute a lane change. For example, the deviation from expected dynamic parameter values may be responsive to the driver swerving to miss a pothole or other road obstacle.

As yet another example, the lane change module 244 may verify the lane change based on the turn signal activity of the vehicle 100. That is, the vehicle 100 may include a sensor that determines when the turn signal is active. If the turn signal is not activated, the lane change module 244 may infer that the vehicle, while departing from expected behavior, did not execute a lane change. By comparison, the turn signal activation and the detected deviation from expected behavior may confirm that a lane change occurred. In any case, rather than relying on a single indicia of a lane change (i.e., a comparison of measured vs. expected values), the lane change module 244 may rely on two-step verification of a lane change to reduce the likelihood of false positive indication of vehicle lane change.

The lane change tracking system 126 also includes a tracking module 246 that includes instructions that cause the processor 236 to, responsive to a verified lane change, track a lane-specific location of the vehicle 100. In some examples, a vehicle 100 may include a GPS that tracks the location of the vehicle 100. In an example, the GPS coordinates of the vehicle 100 may be transmitted to a remote location. The tracked location of the vehicle 100 may be used in various circumstances. For example, the tracked location may be used to update navigational instructions provided to the driver of the vehicle 100. In another example, the tracked location may be used to control the automated driving of an equipped vehicle. As another example, a traffic center 248 may use the tracked location to update traffic conditions. As described above, the GPS systems of some vehicles may not be capable of tracking a lane-level location of the vehicle 100. However, the tracking module 246, relying on verified lane changes, can track the location of the vehicle 100 through the various lanes of a road segment. That is, the tracking module 246 may receive updates from the lane change module 244 each time the vehicle 100 changes lanes. As such, the tracking module 246 may continuously monitor and update the lane in which the vehicle 100 is driving. This information may then be used in a variety of ways.

For example, the tracking module 246 may control the navigation system 116 of the vehicle 100 to present different navigational instructions based on a detected lane of the vehicle 100. As another example, the tracking module 246 may control the automated driving module 125 of the vehicle to control vehicle systems 109 to navigate the vehicle based on the current lane of the vehicle 100 and the lanes of other vehicles. As another example, the tracking module 246 may, via the communication system 127, transmit the lane-specific vehicle location to a traffic center 248 so that lane-specific traffic information may be disseminated to various users such as motorists. Additional details regarding the lane change tracking system 126 control operations are described below in connection with FIG. 12.

Accordingly, the present lane change tracking system 126 not only tracks the lane-specific location of the vehicle 100 but controls particular vehicle and remote systems based on the lane-specific location of the vehicle 100. As such, the lane change tracking system 126 improves vehicle navigation, automated driving, and traffic monitoring by providing lane-specific vehicle navigation, lane-specific automated driving, and lane-specific traffic monitoring. Moreover, the lane change tracking system 126 does so while conserving processing and transmitting bandwidth as expensive image transfer is avoided in favor of less computationally demanding and faster dynamic parameter value transmission.

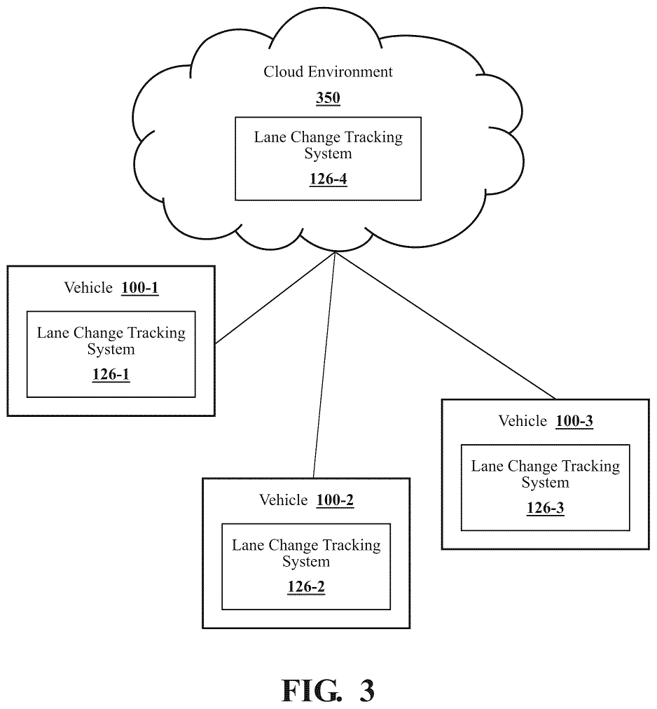

Turning to FIG. 3, the lane change tracking system 126 as illustrated in FIG. 2, is generally an abstracted form of the lane change tracking system 126 as may be implemented between the vehicle 100 and a cloud-computing environment. FIG. 3 illustrates one example of a cloud-computing environment 350 that may be implemented along with the lane change tracking system 126. As illustrated in FIG. 3, the lane change tracking system 126 is embodied at least in part within the cloud-computing environment 350.

In one or more approaches, the cloud-computing environment 350 may facilitate communications between multiple different vehicles to acquire and distribute information between vehicles 100-1, 100-2, and 100-3.

Accordingly, as shown, this environment may include separate instances of the lane change tracking system 126-4 within one or more entities of the cloud-computing environment 350, such as servers, and also instances of the lane change tracking system 126-1, 126-2, and 126-3 within vehicles 100-1, 100-2, and 100-3 that function cooperatively to acquire, analyze, and distribute the noted information. In an example, different functions of the lane change tracking system 126 may be implemented in different instances. For example, the vehicle-based instances of the lane change tracking system 126-1, 126-2, and 126-3 may perform the extraction of detected features and may transmit, via the communication system 127, sensor data 232 to the remote instance of the lane change tracking system 126-4 where the expected value is determined and where a potential lane change is detected and verified.

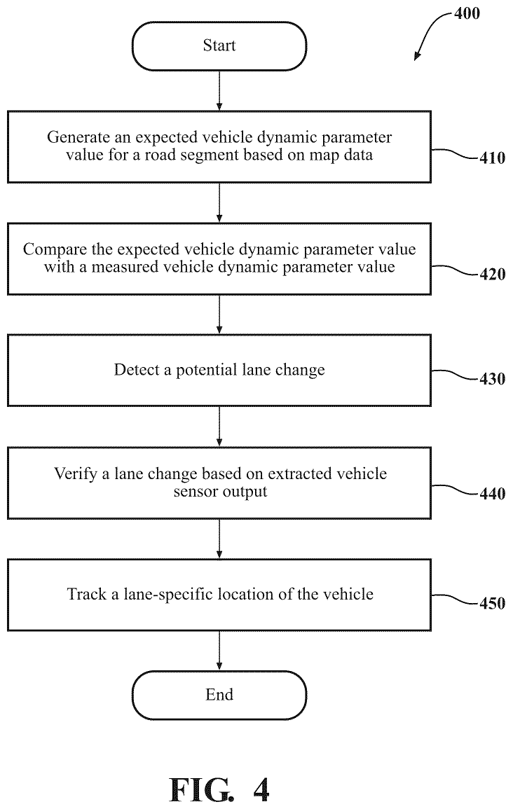

Additional aspects of tracking a vehicle across lanes of a road segment will be discussed in relation to FIG. 4. FIG. 4 illustrates a flowchart of a method 400 that is associated with detecting lane changes of a vehicle 100 based on differences between expected and measured vehicle dynamic parameter values. Method 400 will be discussed from the perspective of the lane change tracking system 126 of FIG. 1, and 2. While method 400 is discussed in combination with the lane change tracking system 126, it should be appreciated that the method 400 is not limited to being implemented within the lane change tracking system 126 but is instead one example of a system that may implement the method 400.

At 410, the method includes generating an expected vehicle dynamic parameter value for a road segment. As described above, the expected vehicle dynamic parameter value is based at least on a feature (e.g., centerline location, curvature, number of lanes, and addition/reduction in the number of lanes) of the road segment. Specifically, the extraction module 240 can extract road features from map data 230, which road features may be encoded in metadata associated with different points (i.e., nodes) along a roadway. Using a lookup table-based expected value model 234, a machine-learning-based expected value model 234, or another type of expected value model 234, the expected value module 242 identifies expected vehicle dynamic parameter values for the road segment. That is, the expected value module 242 may determine expected steering wheel angles, expected wheel angles, expected heading, expected lateral acceleration, and expected yaw measures for a vehicle traveling along the road segment.

At 420, the lane change module 244 compares the expected vehicle dynamic parameter values with measured vehicle dynamic parameter values and, at 430, detects a potential lane change based on the comparison. As described above, differences between measured and expected values may indicate a lane change. That is, the difference between a measured vehicle dynamic parameter value and an expected vehicle dynamic parameter value may indicate that the vehicle 100 is engaging in some behavior other than simply navigating the roadway in one lane. The difference may be a lane change or may be due to some other circumstances, such as swerving to avoid an obstacle in the road. Accordingly, the lane change module 244 identifies differences between measured and expected values and classifies such as a potential lane change.

At 440, the lane change module 244 verifies the lane change by extracting vehicle sensor output indicative of lane change behavior. That is, the additional information (e.g., lane drop, lane addition, the number of lanes on the road segment, a change to lane markers along the road segment, a lateral displacement of the vehicle, or turn signal activity of the vehicle) may indicate whether a potential lane change is or is not an actual lane change. In either case, following verification, the tracking module 246 at 450 tracks a lane-specific location of the vehicle 100. As described above, the lane-specific tracking of a vehicle 100 along a road facilitates improved navigation and automated driving of the vehicle 100 and enhanced traffic monitoring of several vehicles in a region.

FIGS. 5A and 5B depict different vehicle dynamic parameter values for different types of vehicles 100-1 and 100-2. As described above, different vehicles 100-1 and 100-2 may exhibit different dynamic parameter values, even while executing the same maneuver. For example, as depicted in FIG. 5A, a first vehicle 100-1, which may be a semi-truck, may perform a lane change maneuver along a curved road segment 552. In this example, the first vehicle 100-1 may have a first lateral acceleration profile, a first steering wheel angle profile, a first wheel angle profile, a first yaw profile, and a first heading profile along the curved road segment 552. As used in the present specification and in the appended claims, the term “profile” refers to a sequence of individual measurements of the various vehicle dynamic parameters. Still in this example, a second vehicle 100-2, such as a sedan, may perform a similar lane change maneuver along the same curved road segment 552. However, due to the different vehicle characteristics, the second vehicle 100-2 may have a second lateral acceleration profile, a second steering wheel angle profile, a second wheel angle profile, a second yaw profile, and a second heading profile, each of which may be different than the corresponding profiles of the first vehicle 100-1. For example, the first vehicle 100-1 (e.g., the semi-truck) may have a lateral acceleration profile 554-1 that is different than the lateral acceleration profile 554-2 of the second vehicle 100-2. Similarly, a first vehicle wheel 558-1 angle and a first vehicle steering wheel 556-1 angle may be less (i.e., closer to zero) than the second vehicle wheel 558-2 angle and the second vehicle steering sheel 556-2 angle.

As described above, the lane change tracking system 126 of the present specification accounts for these differences. Specifically, the expected value module 242 includes instructions that cause the processor 236 to identify at least one of a type of the vehicle 100 or a characteristic of the vehicle 100. A type of the vehicle may be a classification of the vehicle 100. Example classifications include a body style (e.g., truck, sedan, SUV, semi-truck, towing vehicle) and a make/model/year of the vehicle 100. Characteristics of the vehicle 100 may include those structural or functional characteristics of the vehicle 100 that may impact how the vehicle 100 is operated. Examples of characteristics include wheelbase, length, weight, height, suspension system, etc. While particular examples of types and characteristics of a vehicle 100 are specifically referenced, the expected value module 242 may categorize a vehicle 100 based on other types or other characteristics.

In either case, the vehicle type or characteristic may be identified in various ways. For example, the vehicle 100 may include a vehicle record that indicates the type and/or characteristics of the vehicle 100. In another example, the information may be stored on a remote server. In either case, the lane change tracking system 126 acquires this data and identifies the vehicle type or characteristic.

In this example, the expected value module 242 includes instructions that cause the processor 236 to generate the expected vehicle dynamic parameter value based on the type or the characteristic. As a specific example, responsive to identifying the first vehicle 100-1 as a semi-truck or having a particular weight or wheelbase, the expected value module 242 may output an expected lateral acceleration value for the first vehicle 100-1. By comparison, responsive to identifying the second vehicle 100-2 as a sedan or as being lighter weight and/or having a shorter wheelbase than the first vehicle 100-1, the expected value module 242 may output a second expected lateral acceleration value, which second lateral acceleration value is greater than the first, indicating that it would be expected for the second vehicle 100-2 to make a quicker movement than the first vehicle 100-1.

As described above, in generating the vehicle-specific expected vehicle dynamic parameter value, the expected value module 242 may rely on a lookup table, which may be indexed by, or otherwise account for, the type or characteristic of the vehicle. In an example where the expected value module 242 is a machine-learning module, the type or characteristic of the vehicle 100 may be received as an input, with the machine-learning module being trained (whether supervised, unsupervised, or re-enforced) based on vehicle types and characteristics. Accordingly, the present lane change tracking system 126, rather than providing vehicle agnostic expected parameter values, customizes the analysis of a vehicle lane change to particular characteristics or types of vehicle, thus enhancing the accuracy of lane-level vehicle tracking.

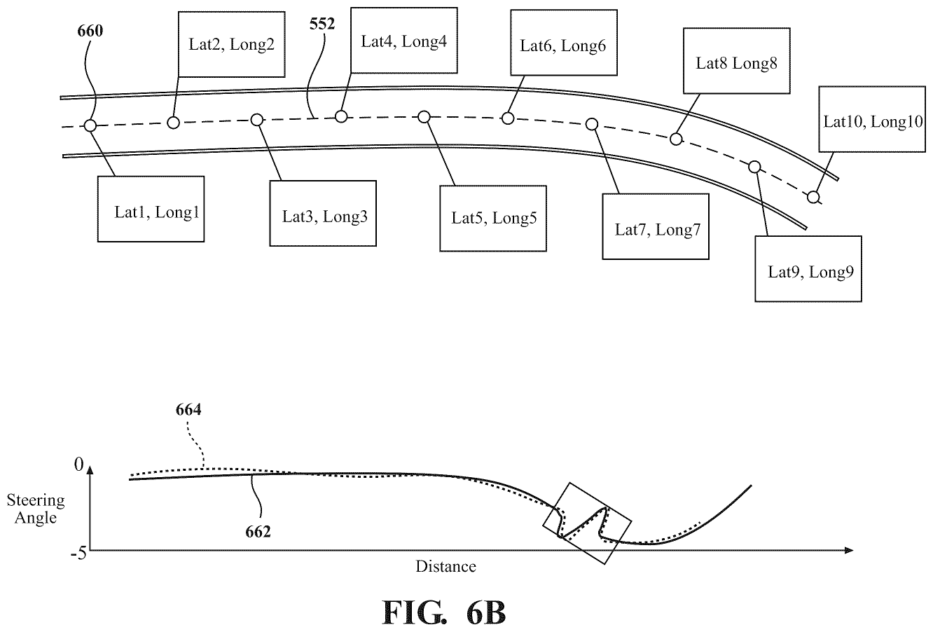

FIGS. 6A and 6B depict the detection of a lane change based on road segment 552 centerline and vehicle steering angle, according to an example of the principles described herein. As described above, the principles described herein facilitate lane-level tracking of a vehicle 100 even across a road segment 552 which is curved as depicted in FIG. 5A-8. As such, where the road segment is a road segment 552 that is curved, the expected vehicle dynamic parameter values indicate an expected dynamic parameter value for a vehicle 100 traveling along the road segment 552 that is curved. Also as described above, the lane change tracking system 126 may determine a variety of expected vehicle parameter values based on a variety of extracted road features. In the example depicted in FIGS. 6A and 6B, the expected value module 242 determines an expected steering wheel angle value over time (i.e., an expected steering wheel angle profile) based on a road segment centerline profile.

As described above, the map data 230 may include centerline data, which indicates the centerline coordinates of a road segment 552 at different longitudinal positions. Specifically, the road segment 552 may be defined by nodes 660. For simplicity, an individual node 660 is represented by a reference number. However, as depicted in FIGS. 6A and 6B, the road segment 552 may be defined by multiple nodes 660. Each node 660 may be defined by coordinates such as latitude and longitude coordinates (e.g., Lat1, Long1; Lat2, Long2; Lat3, Long3; Lat4, Long4; Lat5, Long5; Lat6, Long6; Lat7, Long7; Lat8, Long8; Lat9, Long9; Lat10, Long10), which latitude and longitude coordinates represent the center of the road segment 552. As depicted in FIG. 6A, the latitude and longitude coordinates of the nodes 660 change along a longitudinal direction of the road segment 552.

Based on changes to the latitude and longitude coordinates of the nodes 660 over a distance, the expected value module 242 may determine an expected steering angle profile 662. The expected steering angle profile 662 is the steering angle that a vehicle would be expected to exhibit while following the centerline of the road segment 552. For example, as the vehicle 100 enters a curve, the steering angle may be expected to deviate in one direction. As the vehicle 100 exits the curve, the steering wheel angle may be expected to change in the opposite direction to return to a pre-curve steering wheel position as depicted by the expected steering angle profile 662.

Also as described above, the mapping between the expected steering angle and the centerline of the road may be made via a lookup table in the expected value model 234 or based on machine learning. For example, as the coordinates of the centerline of the road segment 552 change by a certain amount, the lookup table or machine-learning module may identify what corresponding steering wheel angle would allow the vehicle to remain aligned with the centerline. As described above, this expected value may be determined based on characteristics of the vehicle 100, such as the vehicle's turn radius, wheelbase, weight, and steering system 112.

It may be that as the vehicle 100 navigates the curve, the driver simultaneously performs a lane change. To effectuate the lane change, the driver may alter the steering wheel angle of the vehicle 100 beyond or below the amount expected. This alteration may be detected in the measured steering angle profile 664 as a deviation, indicated in the box 668, from the expected steering angle profile 662. Accordingly, the lane change module 244 may cause the processor 236 to differentiate a lane change across the curved road segment 552 from non-lane changing navigation of the curved road segment 552.

Note that in FIG. 6A, the lane change module 244 detects the potential lane change based on a difference between the measured vehicle dynamic parameter value and an expected vehicle dynamic parameter value indicative of a non-lane change behavior. By comparison, as depicted in FIG. 6B, the lane change module 244 may detect the potential lane change based on a similarity between the measured vehicle dynamic parameter value and an expected vehicle dynamic parameter value indicative of a lane change. That is, in the example depicted in FIG. 6B, the expected steering angle profile 662 includes dynamic vehicle parameter values expected when the lane change is executed. Accordingly, rather than determining that a lane change occurs based on a deviation, the lane change module 244 may determine that a lane change occurs based on a similarity. In either case, as described above, the lane change module 244 may verify that the data indicates a lane change and not some other maneuver based on extracted sensor data. The lane change tracking system 126 can then track a vehicle lane location, even when navigating a curved road segment, in a manner that conserves processing resources and transmission bandwidth.

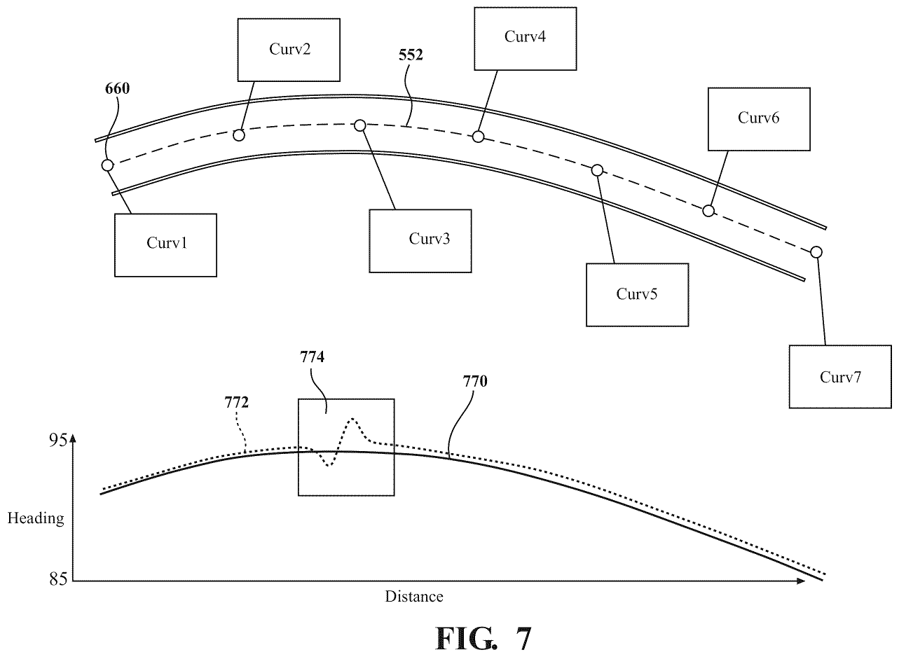

FIG. 7 depicts the detection of a lane change based on road segment curvature and vehicle heading, according to an example of the principles described herein. That is, in the example depicted in FIG. 7, the expected value module 242 determines an expected heading angle value over time (i.e., an expected heading profile) based on a road segment curvature profile.

As described above, the map data 230 may include curvature data (e.g., Curv1, Curv2, Curv3, Curv4, Curv5, Curv6, Curv7) for different nodes 660 along the road segment 552. Based on the curvature data for the different nodes 660, the expected value module 242, either based on a lookup table or machine learning, may determine an expected heading for the vehicle 100 at that point. By performing this operation for each node 660, the expected value module 242 may generate an expected heading profile 770. The expected heading profile 770 defines the heading that a vehicle would be expected to exhibit to follow the road segment 552. In an example, the mapping between the curvature of the road segment 552 and the expected heading value may be linear. In other examples, the mapping may be different.

As described above, the mapping between the expected heading and the curvature of the road may be made via a lookup table in the expected value model 234 or based on machine learning. For example, the lookup table or machine-learning module may identify, per curvature value, what corresponding steering wheel angle would allow the vehicle to remain aligned with the road segment 552. As described above, this expected value may be determined based on characteristics of the vehicle 100, such as the vehicle's turn radius, wheelbase, weight, and steering system 112.

As described above, it may be that as the vehicle 100 navigates the curve, the driver simultaneously performs a lane change. To effectuate the lane change, the driver may alter the heading of the vehicle 100 beyond or below an expected amount. This alteration may be detected in the measured heading profile 772 as a deviation, indicated in the box 774, from the expected heading profile 770.

As described above, following the identification of a deviation that may potentially be a lane change, the lane change module 244 may verify that the data is indicative of a lane change and not some other maneuver. This verification may be based on extracted sensor data. The lane change tracking system 126 can then track a vehicle's lane location, even when navigating a curved road segment, in a manner that conserves processing resources and transmission bandwidth.

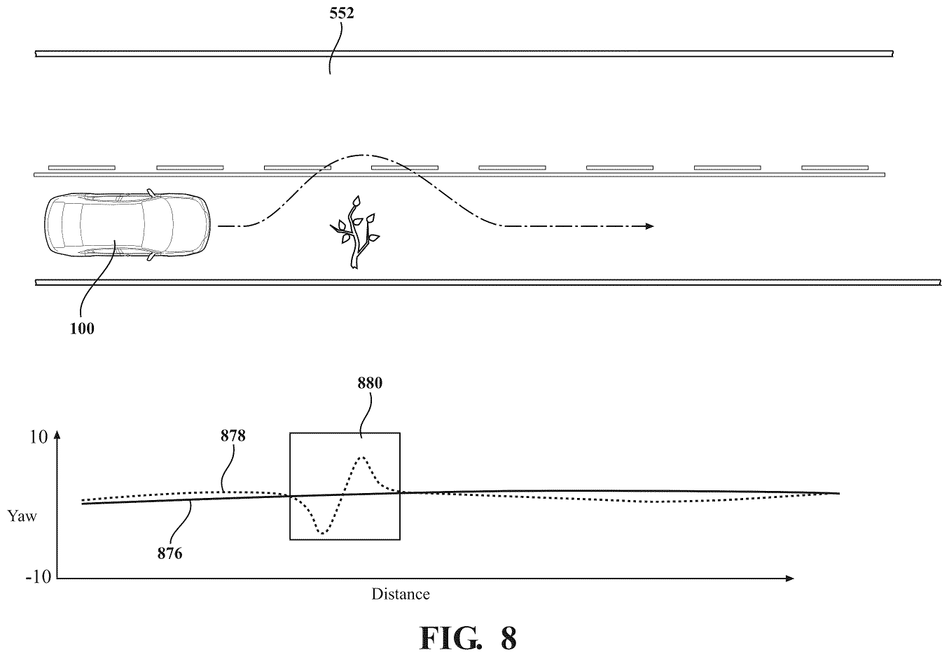

FIG. 8 depicts the detection of a lane change based on the number of lanes on the road segment 552 and vehicle yaw, according to an example of the principles described herein. As described above, in some examples, map data 230 may indicate the number of lanes in road segment 552. For example, the map data 230 that describes the road segment 552 depicted in FIG. 8 may indicate that the road segment 552 is a one-lane road. In another example, the extraction module 240 may determine that the road segment 552 is a one-way road based on the width of the road segment 552.

In either case, based on identifying the road segment 552 as a one-way road, the expected value module 242 may determine an expected yaw profile 876. The expected yaw profile 876 defines the yaw that a vehicle 100 would be expected to exhibit to follow the road segment 552. In an example, yaw may be defined in units of radians or degrees. For example, while navigating a straight one-way road, as depicted in FIG. 8, an expected yaw for the vehicle may be plus or minus 2 degrees.

In this example, the vehicle 100 may include gyroscopes, accelerometers, an inertial measurement unit, or a GPS-based system that measures the yaw of the vehicle 100 as it traverses the road segment 552. The measured values at discrete points in time may be aggregated to define a measured yaw profile 878 for the vehicle 100. As in the above examples, any alteration may be detected in the measured yaw profile 878 as a deviation, indicated in the box 880, from the expected yaw profile 876.

As described above, following the identification of a deviation that may potentially be a lane change, the lane change module 244 may verify that the data is indicative of a lane change and not some other maneuver based on extracted sensor data. While FIG. 8 depicts an example mapping between yaw and a single-lane straight road segment 552, similar operations may generate an expected vehicle dynamic parameter value along multi-lane curved road segments 552.

FIG. 9 depicts the detection of a lane change based on road segment lane data, according to an example of the principles described herein. As described above, the removal or addition of a lane may be indicative of a lane change. For example, as depicted in FIG. 9, a lane, lane 1, that the first vehicle 100-1 is driving in may merge with another lane, lane 2. This merging may indicate that a detected abrupt change in a measured vehicle dynamic parameter value indicates a lane change. Accordingly, while in previous examples, the map data 230 may be lane agnostic and the lane change tracking system 126 would still be able to detect a lane change, in this example, the map data 230 may indicate a number of lanes and changes to the number of lanes along the road segment 552. Accordingly, in this example, the expected value module 242 would generate an expected vehicle dynamic parameter value or profile based on such. For example, as the first vehicle 100-1 is traveling in a lane, lane 1, that merges with another lane, lane 2, the expected value module 242 may generate an expected profile of whatever vehicle dynamic parameter value that accounts for the guided lane change.

By comparison, when a lane, such as lane 2 and lane 3, that the second vehicle 100-2 and third vehicle 100-3 are driving in are not involved in a merge, the expected value module 242 may generate an expected profile, of whatever vehicle dynamic parameter value, that does not account for the guided lane change. In other words, the expected vehicle dynamic parameter values and profiles may be lane-specific.

Note that while FIG. 5A-9 depict various examples where a single road feature is used to determine a single expected vehicle dynamic parameter profile, the lane change tracking system 126 may rely on multiple combinations of road features to determine multiple expected vehicle dynamic parameter profiles. In any of these cases, the lane change tracking system 126 compares the expected values against measured values to determine whether the vehicle 100 made a lane change maneuver and may make this determination even when the vehicle 100 is navigating a curved road segment.

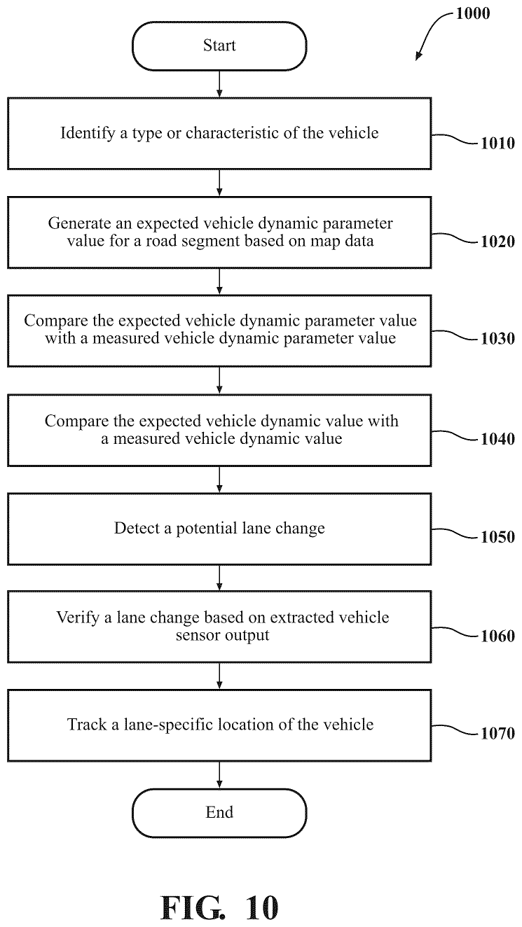

FIG. 10 illustrates a flowchart for one embodiment of a method 1000 that is associated with detecting the lane change maneuvers of a vehicle 100, according to an example of the principles described herein.

At 1010, the lane change tracking system 126 may identify a type or characteristic of the vehicle 100. As described above, this may be done in various ways. For example, the type or characteristic information for the vehicle 100 may be stored locally in the data store 228. In another example, the type or characteristic information may be retrieved from a remote computing device. In either case, the type (e.g., body style or make/model/year information) or characteristic (weight, wheelbase, center of gravity, steering system dynamics, etc.) may be considered when generating the expected vehicle dynamic parameter value at 1020, as described above.

As described above, it may be the case that multiple expected vehicle dynamic parameter values are aggregated over a stretch of road. Accordingly, at 1030, the expected value module 242 generates an expected vehicle dynamic profile, which is a series of expected dynamic parameter values at different positions along a direction of travel of a road segment 552.

At 1040, the lane change module 244 compares the expected vehicle dynamic parameter value or profile against a measured vehicle dynamic parameter value or profile, with differences or similarities indicative of a potential lane change as described above. At 1050, the lane change module 244 verifies the lane change based on extracted vehicle sensor output as described above, and at 1060, the tracking module 246 tracks a lane-specific location of the vehicle 100.

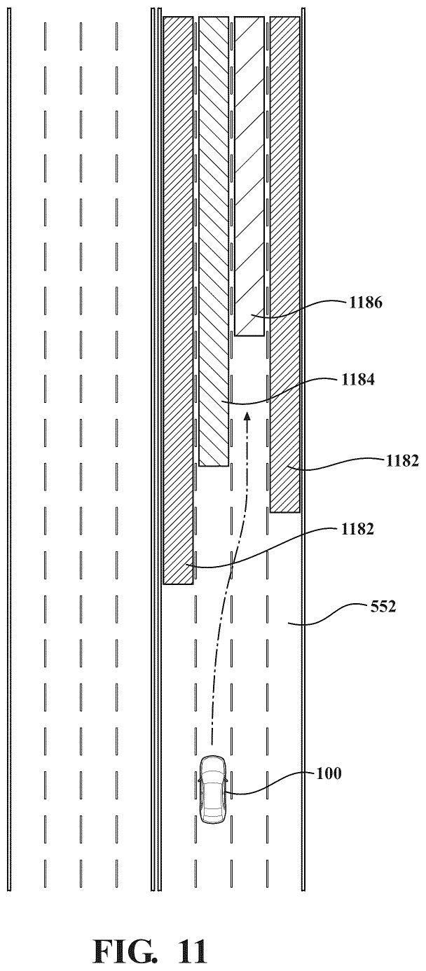

As described above, the lane-specific vehicle tracking can be used in several scenarios to enhance vehicle navigation and/or autonomous control, as depicted in FIG. 11. In one example, the lane change tracking system 126 causes the processor 236 to generate lane-level traffic representations along the road segment 552 by aggregating the lane-specific location of the vehicle 100 and the lane-specific locations of other vehicles. In this example, the lane change tracking system 126, or at least a portion of the lane change tracking system 126, may be disposed at a remote site. In this example, the instances of the lane change tracking system 126 that are found in other vehicles, as depicted in FIG. 3, may transmit an indication of lane changes to the remote server or may transmit sensor data by which the remote server determines whether the vehicles have changed lanes as described above. In either case, this aggregated information may be provided to a traffic center 248, which determines traffic levels in different lanes of a road segment 552. For illustration purposes, different traffic congestion levels are indicated with different hash patterns. For example, a more congested level of traffic is indicated with a first pattern 1182, an intermediate level of traffic congestion is indicated with a second pattern 1184, and a light level of traffic congestion is indicated with a third pattern 1186. As such, the lane change tracking system 126 of the present specification enhances traffic monitoring systems by providing traffic monitoring at the lane level instead of the road level (which may be agnostic to lane-specific traffic).

In an example, the lane change tracking system 126 may include instructions to update navigational instructions to include lane-specific navigation instructions based on the lane-specific location of the vehicle 100. For example, a traffic center 248 may indicate lighter traffic in a lane adjacent to where vehicle 100 is traveling. Accordingly, in this example, the navigation system 116 may provide instructions to guide the vehicle 100 from its current lane to a lane with lighter traffic congestion, as indicated by the arrow. As such, the lane change tracking system 126 of the present specification enhances vehicle navigation systems by providing traffic-based lane-specific navigation instructions.

In an example, the lane change tracking system 126 may include instructions to control the movement of the vehicle 100 across lanes of the road segment 552 based on the lane lane-specific location of the vehicle 100 and lane-specific locations of other vehicles. For example, a traffic center 248 may indicate lighter traffic in a lane adjacent to where vehicle 100 is traveling. Accordingly, in this example, the lane change tracking system 126 may at least partially control an automated driving module 125 and the various vehicle systems 109 to direct the vehicle 100 from its current lane to a lane with lighter traffic congestion, as indicated by the arrow. As such, the lane change tracking system 126 of the present specification enhances automated driving by providing traffic-based lane-specific automated control of the vehicle 100.

FIG. 1 will now be discussed in full detail as an example environment within which the system and methods disclosed herein may operate. In some instances, the vehicle 100 is configured to switch selectively between an autonomous mode, one or more semi-autonomous modes, and/or a manual mode. “Manual mode” means that all of or a majority of the control and/or maneuvering of the vehicle is performed according to inputs received via manual human-machine interfaces (HMIs) (e.g., steering wheel, accelerator pedal, brake pedal, etc.) of the vehicle 100 as manipulated by a user (e.g., human driver). In one or more arrangements, the vehicle 100 can be a manually-controlled vehicle that is configured to operate in only the manual mode.

In one or more arrangements, the vehicle 100 implements some level of automation in order to operate autonomously or semi-autonomously. As used herein, automated control of the vehicle 100 is defined along a spectrum according to the SAE J3016 standard. The SAE J3016 standard defines six levels of automation from level zero to five. In general, as described herein, semi-autonomous mode refers to levels zero to two, while autonomous mode refers to levels three to five. Thus, the autonomous mode generally involves control and/or maneuvering of the vehicle 100 along a travel route via a computing system to control the vehicle 100 with minimal or no input from a human driver. By contrast, the semi-autonomous mode, which may also be referred to as advanced driving assistance system (ADAS), provides a portion of the control and/or maneuvering of the vehicle via a computing system along a travel route with a vehicle operator (i.e., driver) providing at least a portion of the control and/or maneuvering of the vehicle 100.

With continued reference to the various components illustrated in FIG. 1, the vehicle 100 includes one or more processors 101. In one or more arrangements, the processor(s) 101 can be a primary/centralized processor of the vehicle 100 or may be representative of many distributed processing units. For instance, the processor(s) 101 can be an electronic control unit (ECU). Alternatively, or additionally, the processors include a central processing unit (CPU), a graphics processing unit (GPU), an ASIC, a microcontroller, a system on a chip (SoC), and/or other electronic processing units that support operation of the vehicle 100.

The vehicle 100 can include one or more data stores 118 for storing one or more types of data. The data store 118 can be comprised of volatile and/or non-volatile memory. Examples of memory that may form the data store 118 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, solid-state drivers (SSDs), and/or other non-transitory electronic storage medium. In one configuration, the data store 118 is a component of the processor(s) 101. In general, the data store 118 is operatively connected to the processor(s) 101 for use thereby. The term “operatively connected,” as used throughout this description, can include direct or indirect connections, including connections without direct physical contact.

In one or more arrangements, the one or more data stores 118 include various data elements to support functions of the vehicle 100, such as semi-autonomous and/or autonomous functions. Thus, the data store 118 may store map data 119 and/or sensor data 122. The map data 119 includes, in at least one approach, maps of one or more geographic areas. In some instances, the map data 119 can include information about roads (e.g., lane and/or road maps), traffic control devices, road markings, structures, features, and/or landmarks in the one or more geographic areas. The map data 119 may be characterized, in at least one approach, as a high-definition (HD) map that provides information for autonomous and/or semi-autonomous functions.

In one or more arrangements, the map data 119 can include one or more terrain maps 120. The terrain map(s) 120 can include information about the ground, terrain, roads, surfaces, and/or other features of one or more geographic areas. The terrain map(s) 120 can include elevation data in the one or more geographic areas. In one or more arrangements, the map data 119 includes one or more static obstacle maps 121. The static obstacle map(s) 121 can include information about one or more static obstacles located within one or more geographic areas. A “static obstacle” is a physical object whose position and general attributes do not substantially change over a period of time. Examples of static obstacles include trees, buildings, curbs, fences, and so on.

The sensor data 122 is data provided from one or more sensors of the sensor system 102. Thus, the sensor data 122 may include observations of a surrounding environment of the vehicle 100 and/or information about the vehicle 100 itself. In some instances, one or more data stores 118 located onboard the vehicle 100 store at least a portion of the map data 119 and/or the sensor data 122. Alternatively, or in addition, at least a portion of the map data 119 and/or the sensor data 122 can be located in one or more data stores 118 that are located remotely from the vehicle 100.

As noted above, the vehicle 100 can include the sensor system 102. The sensor system 102 can include one or more sensors. As described herein, “sensor” means an electronic and/or mechanical device that generates an output (e.g., an electric signal) responsive to a physical phenomenon, such as electromagnetic radiation (EMR), sound, etc. The sensor system 102 and/or the one or more sensors can be operatively connected to the processor(s) 101, the data store(s) 118, and/or another element of the vehicle 100.

Various examples of different types of sensors will be described herein. However, it will be understood that the embodiments are not limited to the particular sensors described. In various configurations, the sensor system 102 includes one or more vehicle sensors 103 and/or one or more environment sensors. The vehicle sensor(s) 103 function to sense information about the vehicle 100 itself. In one or more arrangements, the vehicle sensor(s) 103 include one or more accelerometers, one or more gyroscopes, an inertial measurement unit (IMU), a dead-reckoning system, a global navigation satellite system (GNSS), a global positioning system (GPS), and/or other sensors for monitoring aspects about the vehicle 100.

As noted, the sensor system 102 can include one or more environment sensors 104 that sense a surrounding environment (e.g., external) of the vehicle 100 and/or, in at least one arrangement, an environment of a passenger cabin of the vehicle 100. For example, the one or more environment sensors 104 sense objects the surrounding environment of the vehicle 100. Such obstacles may be stationary objects and/or dynamic objects. Various examples of sensors of the sensor system 102 will be described herein. The example sensors may be part of the one or more environment sensors 104 and/or the one or more vehicle sensors 103. However, it will be understood that the embodiments are not limited to the particular sensors described. As an example, in one or more arrangements, the sensor system 102 includes one or more radar sensors 105, one or more LiDAR sensors 106, one or more sonar sensors 107 (e.g., ultrasonic sensors), and/or one or more cameras 108 (e.g., monocular, stereoscopic, RGB, infrared, etc.).

Continuing with the discussion of elements from FIG. 1, the vehicle 100 can include an input system 123. The input system 123 generally encompasses one or more devices that enable the acquisition of information by a machine from an outside source, such as an operator. The input system 123 can receive an input from a vehicle passenger (e.g., a driver/operator and/or a passenger). Additionally, in at least one configuration, the vehicle 100 includes an output system 124. The output system 124 includes, for example, one or more devices that enable information/data to be provided to external targets (e.g., a person, a vehicle passenger, another vehicle, another electronic device, etc.).

Furthermore, the vehicle 100 includes, in various arrangements, one or more vehicle systems 109. Various examples of the one or more vehicle systems 109 are shown in FIG. 1. However, the vehicle 100 can include a different arrangement of vehicle systems. It should be appreciated that although particular vehicle systems are separately defined, each or any of the systems or portions thereof may be otherwise combined or segregated via hardware and/or software within the vehicle 100. As illustrated, the vehicle 100 includes a propulsion system 110, a braking system 111, a steering system 112, a throttle system 113, a transmission system 114, a signaling system 115, and a navigation system 116.

The navigation system 116 can include one or more devices, applications, and/or combinations thereof to determine the geographic location of the vehicle 100 and/or to determine a travel route for the vehicle 100. The navigation system 116 can include one or more mapping applications to determine a travel route for the vehicle 100 according to, for example, the map data 119. The navigation system 116 may include or at least provide connection to a global positioning system, a local positioning system or a geolocation system.

In one or more configurations, the vehicle systems 109 function cooperatively with other components of the vehicle 100. For example, the processor(s) 101, the lane change tracking system 126, and/or automated driving module(s) 125 can be operatively connected to communicate with the various vehicle systems 109 and/or individual components thereof. For example, the processor(s) 101 and/or the automated driving module(s) 125 can be in communication to send and/or receive information from the various vehicle systems 109 to control the navigation and/or maneuvering of the vehicle 100. The processor(s) 101, the lane change tracking system 126, and/or the automated driving module(s) 125 may control some or all of these vehicle systems 109.

For example, when operating in the autonomous mode, the processor(s) 101, the lane change tracking system 126, and/or the automated driving module(s) 125 control the heading and speed of the vehicle 100. The processor(s) 101, the lane change tracking system 126, and/or the automated driving module(s) 125 cause the vehicle 100 to accelerate (e.g., by increasing the supply of energy/fuel provided to a motor), decelerate (e.g., by applying brakes), and/or change direction (e.g., by steering the front two wheels). As used herein, “cause” or “causing” means to make, force, compel, direct, command, instruct, and/or enable an event or action to occur either in a direct or indirect manner.

As shown, the vehicle 100 includes one or more actuators 117 in at least one configuration. The actuators 117 are, for example, elements operable to move and/or control a mechanism, such as one or more of the vehicle systems 109 or components thereof responsive to electronic signals or other inputs from the processor(s) 101 and/or the automated driving module(s) 125. The one or more actuators 117 may include motors, pneumatic actuators, hydraulic pistons, relays, solenoids, piezoelectric actuators, and/or another form of actuator that generates the desired control.

As described previously, the vehicle 100 can include one or more modules, at least some of which are described herein. In at least one arrangement, the modules are implemented as non-transitory computer-readable instructions that, when executed by the processor 101, implement one or more of the various functions described herein. In various arrangements, one or more of the modules are a component of the processor(s) 101, or one or more of the modules are executed on and/or distributed among other processing systems to which the processor(s) 101 is operatively connected. Alternatively, or in addition, the one or more modules are implemented, at least partially, within hardware. For example, the one or more modules may be comprised of a combination of logic gates (e.g., metal-oxide-semiconductor field-effect transistors (MOSFETs)) arranged to achieve the described functions, an application-specific integrated circuit (ASIC), programmable logic array (PLA), field-programmable gate array (FPGA), and/or another electronic hardware-based implementation to implement the described functions. Further, in one or more arrangements, one or more of the modules can be distributed among a plurality of the modules described herein. In one or more arrangements, two or more of the modules described herein can be combined into a single module.

Furthermore, the vehicle 100 may include one or more automated driving modules 125. The automated driving module(s) 125, in at least one approach, receive data from the sensor system 102 and/or other systems associated with the vehicle 100. In one or more arrangements, the automated driving module(s) 125 use such data to perceive a surrounding environment of the vehicle. The automated driving module(s) 125 determine a position of the vehicle 100 in the surrounding environment and map aspects of the surrounding environment. For example, the automated driving module(s) 125 determines the location of obstacles or other environmental features including traffic signs, trees, shrubs, neighboring vehicles, pedestrians, etc.

The automated driving module(s) 125 either independently or in combination with the lane change tracking system 126 can be configured to determine travel path(s), current autonomous driving maneuvers for the vehicle 100, future autonomous driving maneuvers and/or modifications to current autonomous driving maneuvers based on data acquired by the sensor system 102 and/or another source. In general, the automated driving module(s) 125 functions to, for example, implement different levels of automation, including advanced driving assistance (ADAS) functions, semi-autonomous functions, and fully autonomous functions, as previously described.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-11, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. The systems, components and/or processes also can be embedded in a computer-readable storage, such as a computer program product or other data program storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. A non-exhaustive list of the computer-readable storage medium can include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or a combination of the foregoing. In the context of this document, a computer-readable storage medium is, for example, a tangible medium that stores a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory storing machine-readable instructions that, when executed by the processor, cause the processor to:
generate an expected vehicle dynamic parameter value for a road segment based on an extracted feature of the road segment from map data;
detect a potential lane change by comparing the expected vehicle dynamic parameter value to a measured vehicle dynamic parameter value of a vehicle traveling along the road segment;
verify a lane change by extracting vehicle sensor output indicative of lane change behavior; and
responsive to a verified lane change, track a lane-specific location of the vehicle.

2. The system of claim 1, wherein:
the road segment is a curved road segment;
the expected vehicle dynamic parameter value indicates an expected vehicle dynamic parameter value for the vehicle traveling along the curved road segment; and
the machine-readable instruction that causes the processor to detect the potential lane change includes a machine-readable instruction that causes the processor to differentiate the potential lane change across the curved road segment from non-lane changing navigation of the curved road segment.

3. The system of claim 1, wherein the machine-readable instruction that causes the processor to generate the expected vehicle dynamic parameter value comprises a machine-readable instruction that causes the processor to compile multiple expected vehicle dynamic parameter values into a profile that comprises multiple location-specific expected vehicle dynamic parameter values at different locations along the road segment.

4. The system of claim 1, wherein the machine-readable instruction that causes the processor to detect the potential lane change comprises at least one of:
a machine-readable instruction that causes the processor to detect the potential lane change based on a difference between the measured vehicle dynamic parameter value and an expected vehicle dynamic parameter value indicative of non-lane change behavior; or
a machine-readable instruction that causes the processor to detect the potential lane change based on a similarity between the measured vehicle dynamic parameter value and an expected vehicle dynamic parameter value indicative of lane change behavior.

5. The system of claim 1, wherein:
the memory further stores a machine-readable instruction that causes the processor to identify at least one of a type of the vehicle or a characteristic of the vehicle; and
the machine-readable instruction that causes the processor to generate the expected vehicle dynamic parameter value comprises a machine-readable instruction that causes the processor to generate the expected vehicle dynamic parameter value based on at least one of the type of the vehicle or the characteristic of the vehicle.

6. The system of claim 1, wherein the memory further stores machine-readable instructions that cause the processor to generate lane-level traffic representations along the road segment by aggregating the lane-specific location of the vehicle with lane-specific locations of other vehicles.

7. The system of claim 1, wherein the memory further stores at least one of:
a machine-readable instruction that causes the processor to update navigational instructions to include lane-specific navigation instructions based on the lane-specific location of the vehicle; or
a machine-readable instruction that causes the processor to control a movement of the vehicle across lanes of the road segment based on the lane-specific location of the vehicle and lane-specific locations of other vehicles.

8. The system of claim 1, wherein the machine-readable instruction that causes the processor to generate the expected vehicle dynamic parameter value comprises a machine-readable instruction that causes the processor to generate the expected vehicle dynamic parameter value based on at least one of:
a centerline of the road segment;
a curvature of the road segment;
a number of lanes of the road segment;
a change to the number of lanes of the road segment; or
lane markers on the road segment.

9. The system of claim 1, wherein:
the expected vehicle dynamic parameter value comprises at least one of:
an expected steering wheel angle value;
an expected lateral acceleration value;
an expected wheel angle value;
an expected heading value; or
an expected yaw value; and
the measured vehicle dynamic parameter value comprises at least one of:
a measured steering wheel angle value;
a measured lateral acceleration value;
a measured wheel angle value;
a measured heading value; or
a measured yaw value.

10. The system of claim 1, wherein the machine-readable instruction that causes the processor to verify the lane change by extracting the vehicle sensor output indicative of lane change behavior comprises a machine-readable instruction that causes the processor to extract at least one of:
a lane drop;
a lane addition;
a number of lanes on the road segment;
a change to lane markers along the road segment;
a lateral displacement of the vehicle; or
turn signal activity of the vehicle.

11. A non-transitory machine-readable medium comprising instructions that, when executed by a processor, cause the processor to:
generate an expected vehicle dynamic parameter value for a road segment based on an extracted feature of the road segment from map data;
detect a potential lane change by comparing the expected vehicle dynamic parameter value to a measured vehicle dynamic parameter value of a vehicle traveling along the road segment;
verify a lane change by extracting vehicle sensor output indicative of lane change behavior; and
responsive to a verified lane change, track a lane-specific location of the vehicle.

12. The non-transitory machine-readable medium of claim 11, wherein:
the road segment is a curved road segment;
the expected vehicle dynamic parameter value indicates an expected dynamic parameter value for a vehicle traveling along the curved road segment; and
the instruction that causes the processor to detect the potential lane change includes an instruction that causes the processor to differentiate the potential lane change across the curved road segment from non-lane changing navigation of the curved road segment.

13. The non-transitory machine-readable medium of claim 11, wherein the instruction that causes the processor to generate the expected vehicle dynamic parameter value comprises an instruction that causes the processor to compile multiple expected vehicle dynamic parameter values into a profile that comprises multiple location-specific expected vehicle dynamic parameter values at different locations along the road segment.

14. The non-transitory machine-readable medium of claim 11, wherein:
the instructions further comprise an instruction that causes the processor to identify at least one of a type of the vehicle or a characteristic of the vehicle; and
the instruction that causes the processor to generate the expected vehicle dynamic parameter value comprises an instruction that causes the processor to generate the expected vehicle dynamic parameter value based on at least one of the type of the vehicle or the characteristic of the vehicle.

15. The non-transitory machine-readable medium of claim 11, wherein the instructions further comprise at least one of:
an instruction that causes the processor to generate lane-level traffic representations along the road segment by aggregating the lane-specific location of the vehicle and lane-specific locations of other vehicles;
an instruction that causes the processor to update navigational instructions to include lane-specific navigation instructions based on the lane-specific location of the vehicle; or
an instruction that causes the processor to control a movement of the vehicle across lanes of the road segment based on the lane-specific location of the vehicle and the lane-specific locations of other vehicles.

16. A method, comprising:
generating an expected vehicle dynamic parameter value for a road segment based on an extracted feature of the road segment from map data;
detecting a potential lane change by comparing the expected vehicle dynamic parameter value to a measured vehicle dynamic parameter value of a vehicle traveling along the road segment;
verifying a lane change by extracting vehicle sensor output indicative of lane change behavior; and
responsive to a verified lane change, tracking a lane-specific location of the vehicle.

17. The method of claim 16, wherein:
the road segment is a curved road segment;
the expected vehicle dynamic parameter value indicates an expected vehicle dynamic parameter value for a vehicle traveling along the curved road segment; and
detecting the potential lane change includes differentiating the potential lane change across the curved road segment from non-lane changing navigation of the curved road segment.

18. The method of claim 16, wherein generating the expected vehicle dynamic parameter value comprises compiling multiple expected vehicle dynamic parameter values into a profile that comprises multiple location-specific expected vehicle dynamic parameter values at different locations along the road segment.

19. The method of claim 16, wherein:
the method further comprises identifying at least one of a type of the vehicle or a characteristic of the vehicle; and
generating the expected vehicle dynamic parameter value comprises generating the expected vehicle dynamic parameter value based on at least one of the type of the vehicle or the characteristic of the vehicle.

20. The method of claim 16, further comprising at least one of:
generating lane-level traffic representations along the road segment by aggregating the lane-specific location of the vehicle and lane-specific locations of other vehicles;
updating navigational instructions to include lane-specific navigation instructions based on the lane-specific location of the vehicle; or
controlling a movement of the vehicle across lanes of the road segment based on the lane-specific location of the vehicle and the lane-specific locations of other vehicles.
